(19) United States
(12) Patent Application Publication
(10) Pub. No.: US 2017/0064644 A1
(43) Pub. Date: Mar. 2, 2017

(54) [11AX] CONDITIONAL SPATIAL REUSE

(71) Applicant: INTEL IP CORPORATION, Santa Clara, CA (US)

(72) Inventors: Laurent CARIOU, Portland, OR (US); Po-Kai HUANG, Santa Clara, CA (US)

(21) Appl. No.: 14/969,415

(22) Filed: Dec. 15, 2015

Related U.S. Application Data
(60) Provisional application No. 62/208,946, filed on Aug. 24, 2015.

(51) Int. Cl. H04W 52/24; H04W 72/08; H04W 72/04

(52) U.S. Cl. CPC H04W 52/243; H04W 72/0473; H04W 72/082; H04W 84/12

(57) ABSTRACT

Some embodiments relate to a wireless network communications using Wireless Local Area Networks (WLAN). Some embodiments relate to high-efficiency wireless local-area networks (HEWs). Some embodiments relate to IEEE 802.11ax (and/or IEEE 802.11ac or IEEE 802.11ax+). Some embodiments relate to methods and devices for spatial reuse in any of these communications environments. Some embodiments relate to conditional reuse for Other Basic Service Set (OBSS) master stations and/or stations. Some embodiments relate to conditions that enable a HEW device to spatially reuse a portion of the wireless medium when the HEW device accurately determines a tolerable interference and either transmits an indication of the tolerable interference and/or lowers its own transmit power in accordance with the accurately determined tolerable or acceptable interference.

### RELATED APPLICATION DATA

This application claims the benefit of and priority under 35 U.S.C. §119(e) to U.S. Patent Application No. 62/208,946, filed Aug. 24, 2015, entitled “APPARATUS, COMPUTER READABLE MEDIUM, AND METHOD FOR CONDITIONAL SPATIAL REUSE IN A HIGH EFFICIENCY WIRELESS LOCAL-AREA NETWORK,” which is incorporated herein by reference in its entirety.

### TECHNICAL FIELD

An exemplary embodiment is directed toward wireless networks. Some embodiments relate to wireless networks that operate in accordance with one of the Institute of Electrical and Electronics Engineers (IEEE) 802.11 standards including the IEEE 802.11-WLAN standards. Some embodiments relate to a wireless network communicating using Wireless Local Area Networks (WLAN). Some embodiments relate to high-efficiency wireless local-area networks (HEWs). Some embodiments relate to IEEE 802.11ax (and/or IEEE 802.11ac or IEEE 802.11ax+). Some embodiments relate to methods and devices for spatial reuse. Some embodiments relate to conditional reuse for Other Basic Service Set (OBSS) master stations and/or stations. Some embodiments relate to conditions that only enable a HEW device to spatially reuse a portion of the wireless medium if the HEW device accurately determines a tolerable interference and either transmits an indication of the tolerable interference and/or lowers the transmit power in accordance with the accurate tolerable interference.

### BACKGROUND

Efficient use of the resources in a wireless local-area network (WLAN) is important to provide bandwidth and acceptable response times to the users of the WLAN. One way to increase the efficiency of a WLAN is spatial re-use where wireless devices may spatially reuse frequencies of the wireless medium. However, often spatial reuse is difficult to achieve. Moreover, wireless devices need to operate with both newer protocols and with legacy devices.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates wireless devices within an exemplary wireless network;

FIG. 2 illustrates spatial reuse with OBSS interference indication in accordance with some embodiments;

FIG. 3 illustrates the components within an exemplary wireless device (AP/STA); and

FIG. 4 is a flowchart illustrating an exemplary method for performing conditional spatial reuse.

### DESCRIPTION OF EMBODIMENTS

Embodiments may be implemented as part of one or more of: IEEE 802.11, IEEE 802.11 WLAN and/or the Wi-Fi Alliance® Technical Committee Hotspot 2.0 Technical Task Group Hotspot 2.0 (Release 2) Technical Specification, Version 2.04, Jan. 2, 2013. However, the embodiments are not limited to IEEE 802.11 standards or Hotspot 2.0 standards. Embodiments can be used in implementation with other wireless communications standards, protocols, and the like.

In the following detailed description, numerous specific details are set forth in order to provide a thorough understanding of the disclosed techniques. However, it will be understood by those skilled in the art that the present embodiments may be practiced without these specific details. In other instances, well-known methods, procedures, components and circuits have not been described in detail so as not to obscure the present disclosure.

Presented herein are embodiments of systems, processes, methods, etc. The embodiments may relate to a communication device and/or communication system. The communication system can include a Wireless Local Area Network (WLAN) connection. A WLAN connection can include communication and association between two or more stations or wireless devices transmitting wide bandwidth PPDUs. The overall design and functionality of the system described herein is, as one example, a means for enhancing spatial reuse.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

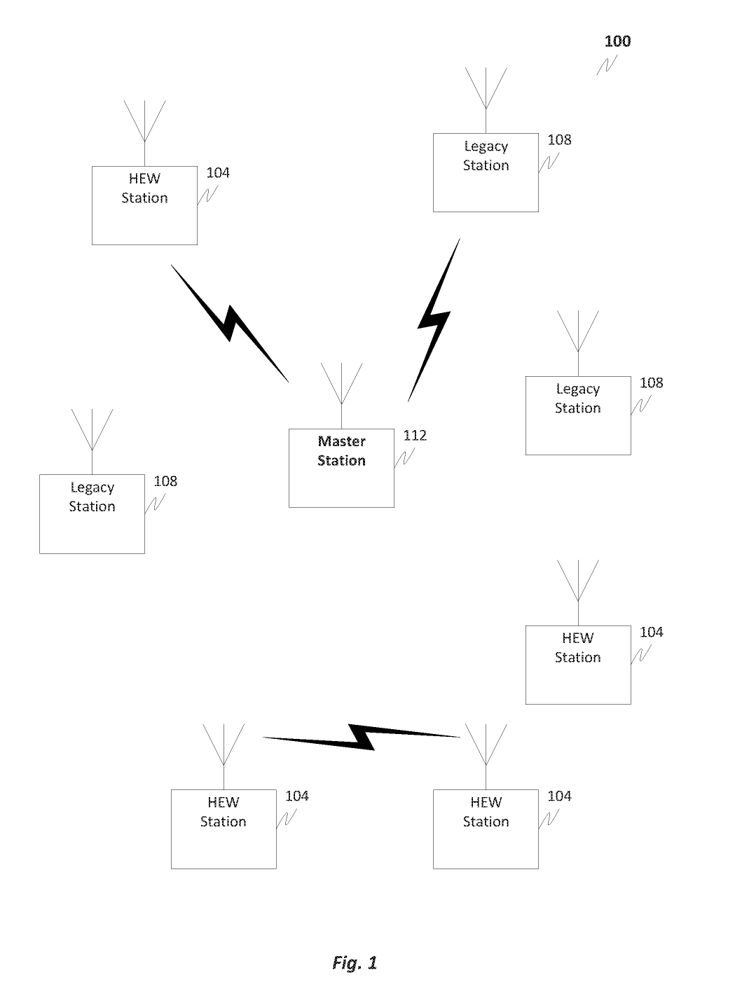

FIG. 1 illustrates an exemplary communications environment 100, such as a WLAN. The exemplary WLAN may comprise a Basis Service Set (BSS) 100 that may include a master station 112, which may be an AP (Access Point), a plurality of high-efficiency wireless (HEW) (e.g., IEEE 802.11ax) STAs 104 and a plurality of legacy (e.g., IEEE 802.11n/ac, etc.) devices/stations 108.

The master station 112 may be an AP using IEEE 802.11 to transmit and receive information. The master station 102 may also be a base station. The master station 112 may use other communications protocols as well as the IEEE 802.11 protocol. The IEEE 802.11 protocol may be IEEE 802.11ax. The IEEE 802.11 protocol may include the use of Orthogonal Frequency Division Multiple-Access (OFDMA), Time Division Multiple Access (TDMA), and/or Code Division Multiple Access (CDMA). The IEEE 802.11 protocol may include a multiple access technique, for example, the IEEE 802.11 protocol may include Space-Division Multiple Access (SDMA) and/or Multiple-User Multiple-Input Multiple-Output (MU-MIMO).

The legacy devices/stations 108 may operate in accordance with one or more of IEEE 802.11 a/b/g/n/ac/ad/af/ah/aj, or another legacy wireless communication standard. The legacy devices 108 may be STAs or IEEE STAs. The HEW STAs 104 may be wireless transmit and receive devices such as cellular telephone, smart telephone, handheld wireless device, wireless glasses, wireless watch, wireless personal device, tablet, and Internet of Things (IoT) device, laptop, tablet, or another device that may be transmitting and receiving using the IEEE 802.11 protocol such as IEEE 802.11ax or another wireless protocol. In some embodiments, the HEW STAs 104 may be termed High Efficiency (HE) stations.

The master station 112 may communicate with legacy devices 108 in accordance with legacy IEEE 802.11 communication techniques. In some exemplary embodiments, the master station 112 may also be configured to communicate with HEW STAs 104 in accordance with legacy IEEE 802.11 communication techniques.

In some embodiments, a HEW frame may be configurable to have the same bandwidth as a subchannel. The bandwidth of a subchannel may be, as non-limiting examples, 20 MHz, 40 MHz, 80 MHz, 160 MHz, or 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 5 MHz and 10 MHz, or a combination thereof or another bandwidth that is less than or equal to the available bandwidth may also be used. In some embodiments the bandwidth of the subchannels may be based on a number of active subcarriers. In some embodiments the bandwidth of the subchannels are multiples of 26 (e.g., 26, 52, 104, etc.) active subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HEW frame may be configured for transmitting a number of spatial streams, which may be in accordance with MU-MIMO. In other embodiments, the master station 112, HEW STA 104, and/or legacy device 108 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.11ax embodiments, the master station 112 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 112 may transmit a HEW master-sync transmission, which may be a trigger frame or HEW control and schedule transmission, at the beginning of the HEW control period. The master station 112 may transmit a time duration of the TXOP and sub-channel information. During the HEW control period, HEW STAs 104 may communicate with the master station 112 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 112 may communicate with HEW stations 104 using one or more HEW frames. During the HEW control period, the HEW STAs 104 may operate on a sub-channel smaller than the operating range of the master station 112. During the HEW control period, legacy stations refrain from communicating.

In accordance with some embodiments, during the master-sync transmission the HEW STAs 104 may contend for the wireless medium with the legacy devices 108 being excluded from contending for the wireless medium during the master-sync transmission. In some embodiments a trigger frame may indicate an uplink (UL) UL-MU-MIMO and/or UL OFDMA control period.

In some embodiments, the multiple-access technique used during the HEW control period may be a scheduled OFDMA technique, although this is not a requirement. In some embodiments, the multiple access technique may be a Time-Division Multiple Access (TDMA) technique or a Frequency Division Multiple Access (FDMA) technique. In some embodiments, the multiple access technique may be a Space-Division Multiple Access (SDMA) technique.

The master station 112 may also communicate with legacy stations 108 and/or HEW stations 104 in accordance with legacy IEEE 802.11 communication techniques. In some embodiments, the master station 112 may also be configurable to communicate with HEW stations 104 outside the HEW control period in accordance with legacy IEEE 802.11 communication techniques, although this is not a requirement.

In exemplary embodiments, the HEW device 104 and/or the master station 112 are configured to perform the methods and functions herein described.

Some embodiments enable improved spatial reuse between neighbouring BSSs in, for example, dense environments. Some embodiments enable a HEW STA 104 and/or the master station 112 to reuse the channel.

One exemplary embodiment is directed toward receiving overlapping Basic Service Set (OBSS) packets that contain an “interference level” or a “spatial reuse” parameter value or metric. This value can be understood as an accurate identification of the interference that can be tolerated by the receiver of the current transmission. In some embodiments, the HEW STA 104 and/or master station 112 is configured to not interfere with the OBSS transmission above the advertised interference level. In some embodiments, the HEW STA 104 and/or master station 112 may be configured to not transmit unless the HEW STA 104 and/or master station 112 can ensure that it will not interfere with an OBSS transmission based on one or more of the spatial reuse parameters.

This technique, that can be referred to as “spatial reuse with OBSS interference indication” works if all HEW STAs 104 and/or master station 112 actually include in their transmission a correct or accurate “interference level” indication.

Indicating this value doesn't benefit the HEW STA 104 and/or master station 112 directly, but rather allows other STAs to reuse the channel and create interference (even if it is a moderated interference). An incentive to include an accurate representation of this value, instead of a basic (or inaccurate) value that will disable any possible reuse, is therefore not strong for the HEW STA 104 and/or master station 112. It is not stronger than the incentive that as HEW STA 104 and/or master station 112 would have to reduce its TxPower (transmit power) when the device has some margin, in order to reduce the interference that the device generates for the other HEW STAs 104 and/or master stations 112.

In accordance with an exemplary embodiment, spatial reuse in a specific area relies on the fact that these HEW STAs 104 and/or master stations 112 will indicate properly or accurately this “interference level” value, even if the HEW STAs 104 and/or master stations 112 do not have any direct benefit in doing so.

In some embodiments, conditions are established that provide incentives for a HEW STA 104 and/or a master station 112 to determine and transmit spatial reuse parameters that enable other HEW STAs 104 and/or master stations 112 to spatially reuse the wireless medium.

In some exemplary embodiments, a HEW STA 104 and/or master station 112 may perform “spatial reuse with an OBSS interference indication” when receiving OBSS signals, only when, for example: the STAs correctly signal their “interference level” and TxPower value(s) in their transmitted packets—this allows other STAs to reuse or reduce their TxPower by the path loss margin—and the STA reduces its TxPower by the same margin calculated and signalled.

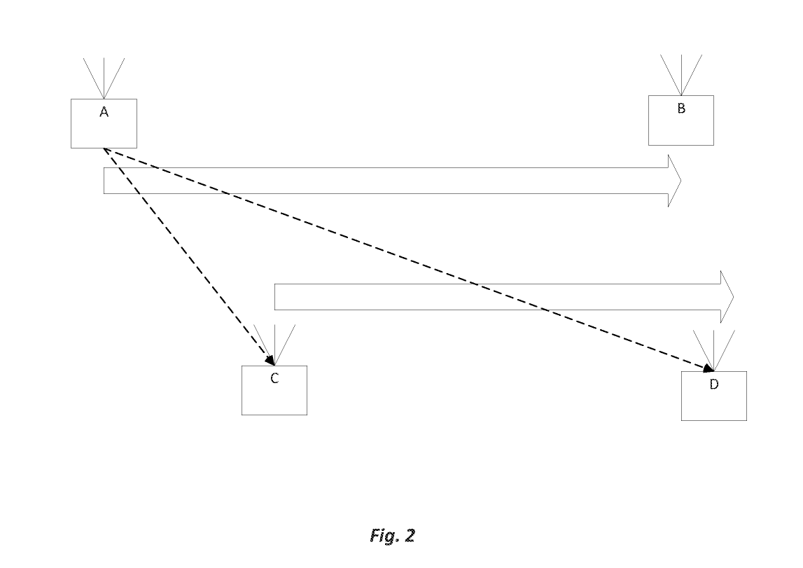

FIG. 2 illustrates spatial reuse with OBSS interference indication in accordance with an exemplary embodiment. A, B, C and D may be HEW STAs and/or a master station(s). In the embodiment in FIG. 2, A to B is an ongoing (existing) communications link, and C to D is a new link that tries to spatially reuse the channel.

When transmitting to B, A may include in its preamble an interference level, and its TxPower. Alternatively, A may transmit only one metric, which may be termed a spatial reuse metric that at least combines both interference level and TxPower.

C detects the preamble of A and tries to reuse the channel to transmit to D. C may only transmit to D if C is sure that it will not interference with B (ongoing link). For that, C has to make sure that C′s transmission will arrive at A (assuming distance A−C=C−B) below the “interference level.” The TxPower level transmitted by A allows C to calculate the path loss to A, and consequently the interference level that C′s transmissions will create.

In some embodiments, the mechanism works if A advertises a correct or accurate ‘interference level,” and not an “interference level” which would incorrectly not allow C to reuse the channel at the same time.

However, A has no direct incentive to provide this “interference level” correctly, as this correct interference level benefits other STAs (and leads to a situation where other STAs are more aggressive than A if they don't determine and communicate the metric correctly).

If all STAs correctly determine and communicate this metric though, all STAs benefit. This is the same situation with the TxPower control which is not used. In some embodiments, if the HEW STAs and/or master stations don't “play the game” and provide a correct value for the interference level, then spatial reuse may not be possible and communications may not be as efficient.

In accordance with one exemplary embodiment, in order to solve at least the above-identified problem, one condition or qualification to this spatial reuse mechanism may be added. The condition is that A in FIG. 2 will be allowed to use this spatial reuse mechanism on other ongoing links, only if it advertises correctly the interference level and TxPower values that reflect reasonable levels of interference that A can tolerate, and a reasonable estimate of A′s TxPower; or, if A reduces its TxPower by the same margin with which it calculated the interference level (margin equal interference level—noise floor). In some embodiments, the reduction in the TxPower and/or determination of a tolerable interference level may be on a per channel basis. In some embodiments the determination of the tolerable interference level may be within a threshold value that permits a reasonable level of reliability for the HEW STA and/or master station.

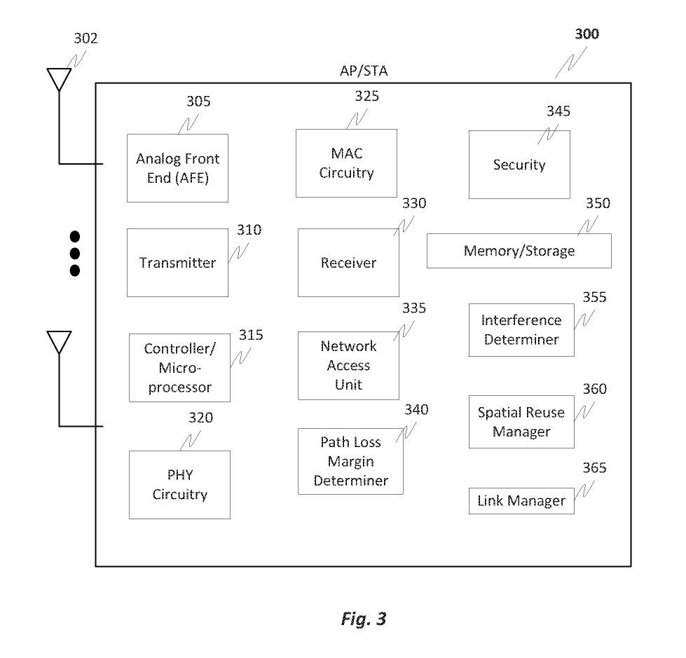

An example of a station (STA) (master and/or HEW) architecture is shown in FIG. 3. The STA 300 may comprise hardware circuitry and/or software that conduct various operations. The STA 300 also includes conventional and well known components which have been omitted for clarity. The operations can include, but are not limited to, conducting calls, synchronizing with other APs, opening multiple applications, presenting information through audio and/or video means, communicating via a WLAN, etc. The STA 300 can be any type of computing system operable to conduct the operations described here. As an example, the STA 300 can be a mobile phone, e.g., smartphone, tablet, laptop, communications device, etc., which includes and interacts with various modules and components as shown in FIG. 3.

More specifically, FIG. 3 illustrates an exemplary HEW device 300 in accordance with some embodiments. The HEW device 300 may be an HEW compliant device that may be arranged to communicate with one or more other HEW devices, such as HEW STAs 104 (FIG. 1) or master station 112 (FIG. 1) as well as communicate with legacy devices 108 (FIG. 1).

The HEW STAs 104 and legacy devices 108 may also be referred to as HEW devices and legacy STAs, respectively. The HEW device 300 may be suitable for operating as master station 112 (FIG. 1) or a HEW STA 104 (FIG. 1).

The STA 300 can have one more antennas 302, for use in wireless communications such as WLAN, multi-input multi-output (MIMO) communications, Bluetooth®, etc. The antennas 302 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users. The antennas at the STAs could also be a special type of antenna, e.g., a co-located dual-polarized antenna, which provides good isolation between transmission and reception to help mitigate self-interference at the receiving chain. In some multiple-input multiple-output (MIMO) embodiments, the antennas may be effectively separated to take advantage of spatial diversity and the different channel characteristics that may result.

Antennas 302 generally interact with an Analog Front End (AFE) module 305, which is needed to enable the correct processing of the received modulated signal and signal conditioning for a transmitted signal. The AFE 305 can be functionally located between the antenna and a digital baseband system in order to convert the analog signal into a digital signal for processing and vice-versa.

In accordance with some exemplary embodiments, the HEW device 300 may include, among other things, physical (PHY) circuitry 320, and media access control (MAC) circuitry 325. PHY circuitry 320 and MAC circuitry 325 may be HEW compliant layers and may also be compliant with one or more legacy IEEE 802.11 standards. MAC circuitry 325 may be arranged to configure packets such as a physical layer convergence procedure (PLCP) protocol data unit (PPDUs) and arranged to transmit and receive PPDUs, among other things. The HEW device 300 may also include a controller 315 and memory 350 configured to perform the various operations described herein. The controller 315 may be electrically coupled to the transceiver (transmitter 310/receiver 330), which may be coupled to the antenna(s) 302. While FIG. 3 depicts the processor and the transceiver as separate components, the processor and transceiver may be integrated together in an electronic package or chip.

In some embodiments, the MAC circuitry 325 may be arranged to contend for a wireless medium during a contention period to receive control of the medium for the HEW control period and configure an HEW PPDU. In some embodiments, the MAC circuitry 325 may be arranged to contend for the wireless medium based on channel contention settings, a transmitting power level, and/or a CCA level.

The PHY circuitry 320 may be arranged to transmit the HEW PPDU. The PHY circuitry 320 may include circuitry for modulation/demodulation, upconversion/downconversion, filtering, amplification, etc. In some embodiments, the circuitry 320 may include one or more processors. The circuitry 320 may be configured to perform functions based on instructions being stored in a RAM or ROM, or based on special purpose circuitry. The circuitry 320 may include processing circuitry and/or transceiver circuitry in accordance with some embodiments. The circuitry 320 may include a processor such as a general purpose processor or special purpose processor. The circuitry 320 may implement one or more functions associated with transmit/receive componentry discussed herein, the MAC circuitry 325, the AFE 305 and/or the memory 350.

In some embodiments, the STA 300 may be configured to perform one or more of the functions and/or methods described herein and/or in conjunction with figures appended hereto, such as decoding or encoding LDPCs with a larger code word size than legacy LDPCs code word sizes.

In some embodiments, the transmitter 310 and receiver 330 can use two or more antennas 302 that may be coupled to the PHY circuitry 320 and arranged for sending and receiving signals including transmission of the HEW packets. The transceiver components may transmit and receive data such as HEW PPDU and packets that include an indication that the HEW device 300 should adapt the channel contention settings according to settings included in the packet. The memory 350 may store information for configuring the other circuitry to perform operations for configuring and transmitting HEW packets and performing the various operations to perform one or more of the functions and/or methods described herein.

In some embodiments, the HEW device/STA 300 may be configured to communicate using OFDM communication signals over a multicarrier communication channel. In some embodiments, the HEW device 300 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described herein, although the scope of the invention is not limited in this respect, as they may also be suitable to transmit and/or receive communications in accordance with other techniques and standards. In some embodiments, the HEW device 300 may use the 4x symbol duration of 802.11n or 802.11ac.

In some embodiments, the device 300 may be part of a portable wireless communication device, such as a personal digital assistant (PDA), a laptop or portable computer with wireless communication capability, a tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11 or IEEE 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The STA 300, as discussed above, can also include a controller/microprocessor 315 and a memory/storage 350. The STA 300 can interact with the memory/storage 250 which may store information and operations necessary for configuring and transmitting or receiving the messages/information described herein. The memory/storage 250 may also be used in connection with the execution of application programming or instructions by the controller/microprocessor 315, and for temporary or long term storage of program instructions and/or data. As examples, the memory/storage 250 may comprise a computer-readable device, RAM, ROM, DRAM, SDRAM or other storage devices and media.

The controller/microprocessor 315 may comprise a general purpose programmable processor or controller for executing application programming or instructions related to the STA 300. Further, controller/microprocessor 315 can perform operations for determining, configuring and transmitting messages/information as described herein. The controller/microprocessor 315 may include multiple processor cores, and/or implement multiple virtual processors. Optionally, the controller/microprocessor 315 may include multiple physical processors. By way of example, the controller/microprocessor 315 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The STA 300 includes, as discussed, a transmitter 310 and receiver 330 which can transmit and receive signals, respectively, to and from other STAs or access points using the one or more antennas 302, AFE 305 and other elements as described above. Included in the STA 300 circuitry is the medium access control or MAC/NAV (Media Access Control/Network Allocation Vector) circuitry 325. MAC/NAV circuitry 325 provides the medium for controlling access to the wireless medium. In an exemplary embodiment, the MAC/NAV circuitry 325 may be arranged to contend for a wireless medium and configure frames, packets, messages and/or information for communicating over the wireless medium.

The STA 200 can also optionally contain a security module 345. This security module 345 can contain information regarding, but not limited to, security parameters required to connect the STA 300 to an AP or other available networks or network devices, and can include WEP or WPA/WPA-2 (optionally+ABS and/or TKIP) security access keys, network keys, etc. A WEP security access key is a security password used by Wi-Fi networks. Knowledge of this code will enable the STA 300 to exchange information with an access point. The information exchange can occur through encoded messages with the WEP access code often being chosen by the network administrator. WPA is an added security standard that is also used in conjunction with network connectivity with stronger encryption than WEP.

Another module that the STA 300 can include is the network access unit 335. The network access unit 335 can be used for connecting with, for example, an AP or master station. In one exemplary embodiment, connectivity can include synchronization between devices. In another exemplary embodiment, the network access unit 335 can work as a medium which provides support for communication with other stations. In yet another embodiment, the network access unit 335 can work in conjunction with at least the MAC/NAV circuitry 325 and/or PHY circuitry 320. The network access unit 335 can also work and interact with one or more of the modules/components described herein.

The device 300 also includes an interference determiner 355, a spatial reuse manager 360 and a link manager 365. In operation, a STA with an existing link (for example between STA A and STA B in FIG. 2), uses the interference determiner 355 to determine an accurate or correct interference level and/or TxPower value (Spatial Reuse Metric). The determination of the accurate interference level can be determined in accordance with any of the well-known interference level determination techniques.

Next, and in cooperation with the transmitter 310 and antenna(s) 302, the device 300 transmits this determined Spatial Reuse Metric (SRM) to STA B, which can also be received by other STAs.

For example, if another station (STA C) receives the Spatial Reuse Metric, STA C can reuse the channel to transmit to STA D when the transmission does not interfere with the STA A→STA B transmissions. STA C reuses the channel by the spatial reuse determiner 360, path loss margin determiner 340, processor 315 and memory 350 determining the path loss to STA A based on the received TxPower Level in the SRM. Based on this determination, STA C, cooperating with the spatial reuse manager 360 and link manager 365, can reuse the channel (link) without interfering with STA A's transmission and optionally also determine and transmit its own SRM for the benefit of other STAs.

As discussed, one added benefit of this technique is that STA A, in cooperation with the spatial reuse manager 360 and link manager 365 can reuse the channel to transmit to other STAs on another link—this is enabled by the transmitting of an accurate interference level and/or when STA A reduces its own TxPower by the same margin communicated in its SRM.

Although the device(s) 300 are illustrated as having several separate functional elements, one or more of the functional elements may be combined and may be implemented by combinations of software- and/or hardware-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

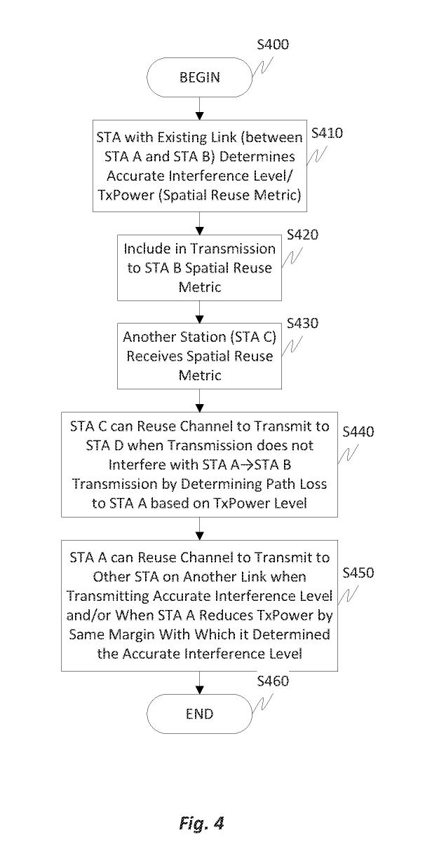

FIG. 4 outlines an exemplary method for spatial reuse. In particular, control begins in step S400 and continues to step S410. In step S410, a first STA with an existing communications link to a second STA determines an accurate or correct interference level and/or TxPower value. These values can be communicated as a Spatial Reuse Metric (SRM) to the second and other STAs. The determination of the accurate interference level by the first STA can be determined in accordance with any of the well-known interference level determination techniques.

Next, in Step S420, the first STA transmits this determined Spatial Reuse Metric (SRM) to the second STA, with this metric also being capable of being received by other STAs in proximity to the first STA in step S430.

Then, for example in step S440, if a third STA receives the Spatial Reuse Metric, the third STA can reuse the channel to transmit to a fourth STA when the transmission from the third STA does not interfere with the communications between the first STA and the second STA. The third STA can reuse the channel by determining the path loss to the first STA based on the received TxPower Level received from the first STA in, for example, the SRM. Based on this determination, the third STA, can reuse the channel (link) without interfering with communications from the first STA, and optionally also determine and transmit its own SRM for the benefit of other STAs.

As discussed, one added benefit of this technique is that the first STA, in step S450, can reuse the channel to transmit to other STAs on another link(s)—this is enabled by the transmitting of an accurate interference level and/or when the first STA reduces its own TxPower by the same margin communicated in its SRM.

Control then continues to step S460 where the control sequence ends.

While the techniques discussed herein have been specifically discussed in relation to IEEE 802.11 systems, it should be appreciated that the techniques discussed herein can generally be applicable to any type of wireless communication standard, protocol, and/or equipment. Moreover, all the flowcharts have been discussed in relation to a set of exemplary steps, it should be appreciated that some of these steps could be optional and excluded from the operational flow without affecting the success of the technique. Additionally, steps provided in the various flowcharts illustrated herein can be used with other techniques illustrated herein.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments have been described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein.

Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

It should also be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof Similarly, one or more of the functional portions of the system could be distributed between a transceiver and an associated computing device/system.

Furthermore, it should be appreciated that the various links (which may not be shown connecting the elements), including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuit, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to 802.11 communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the description omits well-known structures and devices that may be shown in block diagram form or otherwise summarized.

Exemplary aspects are directed toward:

A wireless system, comprising:
an interference determiner configured to determine a first interference level which a first wireless device can tolerate;
a transmitter and spatial reuse manager configured to either transmit a first indication of the first interference level, or to lower a first transmit power level that the first wireless device will use to transmit based on the first interference level;
a receiver configured to receive from a second wireless device a second indication of a second interference level that the second wireless device can tolerate;
the spatial reuse manager further configured to determine a second transmit power level, wherein the second transmit power level is based on the second interference level, wherein the transmitter is further configured to transmit on a same channel as the second wireless device with the second transmit power level.

Any of the above aspects, further comprising one or more of an analog front end, a security module, memory, one or more antennas, MAC circuitry, and a network access unit.

Any of the above aspects, wherein the first indication includes the first interference level and an indication of transmission power to be used to transmit the first indication.

Any of the above aspects, wherein the first wireless device is not permitted to transmit on the same channel as the second wireless device unless the first indication includes an accurate indication of the first interference level.

Any of the above aspects, further comprising a link manager that cooperates with the spatial reuse manager to determine whether the wireless device is permitted to spatially reuse a channel based on whether the wireless device either transmitted the first indication of the first interference level or lowered the first transmit power that the wireless device used to transmit based on the first interference level, wherein the first interference level accurately reflects an amount of interference that does not interfere with the wireless device's communications.

Any of the above aspects, wherein the first wireless device is not permitted to transmit on the same channel as the second wireless device unless the first indication includes an accurate indication of the first interference level or the first transmit power is based on an accurate determination of the first interference level.

Any of the above aspects, wherein the second transmit power level is determined to not interfere with communications at the second wireless device based on the second interference level.

Any of the above aspects, wherein the wireless device is a High-Efficiency Wireless (HEW) device or station.

Any of the above aspects, wherein the second wireless device is associated with a different Other Basic Service Set (OBSS).

Any of the above aspects, further comprising a third wireless device including a second transmitter and a second spatial reuse manager configured to either transmit a third indication of a third interference level, or to lower a third transmit power level that the third wireless device will use to transmit, wherein the third transmit power level is based on the third interference level.

A method of operating a wireless communications network comprising:
determining a first interference level which a wireless device in the wireless communications network can tolerate;
either transmitting a first indication of the first interference level, or lowering a first transmit power level that the wireless device will use to transmit based on the first interference level;
receiving from a second wireless device a second indication of a second interference level that the second wireless device can tolerate;
determining a second transmit power level, wherein the second transmit power level is based on the second interference level, wherein the transmitter is further configured to transmit on a same channel as the second wireless device with the second transmit power level.

Any of the above aspects, wherein the wireless device comprises one or more of an analog front end, a security module, memory, one or more antennas, MAC circuitry, and a network access unit.

Any of the above aspects, wherein the first indication includes the first interference level and an indication of transmission power to be used to transmit the first indication.

Any of the above aspects, wherein the first wireless device is not permitted to transmit on the same channel as the second wireless device unless the first indication includes an accurate indication of the first interference level.

Any of the above aspects, further comprising determining whether the wireless device is permitted to spatially reuse a channel based on whether the wireless device either transmitted the first indication of the first interference level or lowered the first transmit power that the wireless device used to transmit based on the first interference level, wherein the first interference level accurately reflects an amount of interference that does not interfere with the wireless device's communications.

Any of the above aspects, wherein the first wireless device is not permitted to transmit on the same channel as the second wireless device unless the first indication includes an accurate indication of the first interference level or the first transmit power is based on an accurate determination of the first interference level.

Any of the above aspects, wherein the second transmit power level is determined to not interfere with communications at the second wireless device based on the second interference level.

Any of the above aspects, wherein the wireless device is a High-Efficiency Wireless (HEW) device or station.

Any of the above aspects, wherein the second wireless device is associated with a different Other Basic Service Set (OBSS).

Any of the above aspects, further comprising transmitting a third indication of a third interference level, or lowering a third transmit power level that a third wireless device will use to transmit, wherein the third transmit power level is based on the third interference level.

A non-transitory computer-readable information storage media, having stored thereon instructions, that when executed by a processor, perform a method for operating a wireless communications network, comprising:

determining a first interference level which a wireless device in the wireless communications network can tolerate;
either transmitting a first indication of the first interference level, or lowering a first transmit power level that the wireless device will use to transmit based on the first interference level;
receiving from a second wireless device a second indication of a second interference level that the second wireless device can tolerate;
determining a second transmit power level, wherein the second transmit power level is based on the second interference level, wherein the transmitter is further configured to transmit on a same channel as the second wireless device with the second transmit power level.

Any of the above aspects, wherein the wireless device comprises one or more of an analog front end, a security module, memory, one or more antennas, MAC circuitry, and a network access unit.

Any of the above aspects, wherein the first indication includes the first interference level and an indication of transmission power to be used to transmit the first indication.

Any of the above aspects, wherein the first wireless device is not permitted to transmit on the same channel as the second wireless device unless the first indication includes an accurate indication of the first interference level.

Any of the above aspects, further comprising determining whether the wireless device is permitted to spatially reuse a channel based on whether the wireless device either transmitted the first indication of the first interference level or lowered the first transmit power that the wireless device used to transmit based on the first interference level, wherein the first interference level accurately reflects an amount of interference that does not interfere with the wireless device's communications.

Any of the above aspects, wherein the first wireless device is not permitted to transmit on the same channel as the second wireless device unless the first indication includes an accurate indication of the first interference level or the first transmit power is based on an accurate determination of the first interference level.

Any of the above aspects, wherein the second transmit power level is determined to not interfere with communications at the second wireless device based on the second interference level.

Any of the above aspects, wherein the wireless device is a High-Efficiency Wireless (HEW) device or station.

Any of the above aspects, wherein the second wireless device is associated with a different Other Basic Service Set (OBSS).

Any of the above aspects, further comprising transmitting a third indication of a third interference level, or lowering a third transmit power level that a third wireless device will use to transmit, wherein the third transmit power level is based on the third interference level.

A wireless system, comprising:

means for determining a first interference level which a wireless device in the wireless communications network can tolerate;

means for either transmitting a first indication of the first interference level, or lowering a first transmit power level that the wireless device will use to transmit based on the first interference level;

means for receiving from a second wireless device a second indication of a second interference level that the second wireless device can tolerate;

means for determining a second transmit power level, wherein the second transmit power level is based on the second interference level, wherein the transmitter is further configured to transmit on a same channel as the second wireless device with the second transmit power level.

Any of the above aspects, wherein the wireless system further comprises one or more of an analog front end, a security module, memory, one or more antennas, MAC circuitry, and a network access unit.

Any of the above aspects, wherein the first indication includes the first interference level and an indication of transmission power to be used to transmit the first indication.

Any of the above aspects, wherein the first wireless device is not permitted to transmit on the same channel as the second wireless device unless the first indication includes an accurate indication of the first interference level.

Any of the above aspects, further comprising determining whether the wireless device is permitted to spatially reuse a channel based on whether the wireless device either transmitted the first indication of the first interference level or lowered the first transmit power that the wireless device used to transmit based on the first interference level, wherein the first interference level accurately reflects an amount of interference that does not interfere with the wireless device's communications.

Any of the above aspects, wherein the first wireless device is not permitted to transmit on the same channel as the second wireless device unless the first indication includes an accurate indication of the first interference level or the first transmit power is based on an accurate determination of the first interference level.

Any of the above aspects, wherein the second transmit power level is determined to not interfere with communications at the second wireless device based on the second interference level.

Any of the above aspects, wherein the wireless device is a High-Efficiency Wireless (HEW) device or station.

Any of the above aspects, wherein the second wireless device is associated with a different Other Basic Service Set (OBSS).

Any of the above aspects, further comprising a third wireless device including a second transmitter and a second spatial reuse manager configured to transmit a third indication of a third interference level, or lowering a third transmit power level that a third wireless device will use to transmit, wherein the third transmit power level is based on the third interference level.

Any one or more of the features as substantially disclosed herein.

For purposes of explanation, numerous details are set forth in order to provide a thorough understanding of the present embodiments. It should be appreciated however that the techniques herein may be practiced in a variety of ways beyond the specific details set forth herein.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, WiFi, LTE, 4G, Bluetooth®, WirelessHD, WiGig, WiGi, 3GPP, Wireless LAN, WiMAX, LiFi, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Provided herein are exemplary systems and methods for spatial reuse in a communications environment. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless system, comprising:
an interference determiner configured to determine a first interference level which a first wireless device can tolerate;
a transmitter and spatial reuse manager configured to either transmit a first indication of the first interference level, or to lower a first transmit power level that the first wireless device will use to transmit based on the first interference level;
a receiver configured to receive from a second wireless device a second indication of a second interference level that the second wireless device can tolerate;
the spatial reuse manager further configured to determine a second transmit power level, wherein the second transmit power level is based on the second interference level, wherein the transmitter is further configured to transmit on a same channel as the second wireless device with the second transmit power level.

2. The system of claim 1, further comprising one or more of an analog front end, a security module, memory, one or more antennas, MAC circuitry, and a network access unit.

3. The system of claim 1, wherein the first indication includes the first interference level and an indication of transmission power to be used to transmit the first indication.

4. The system of claim 1, wherein the first wireless device is not permitted to transmit on the same channel as the second wireless device unless the first indication includes an accurate indication of the first interference level.

5. The system of claim 1, further comprising a link manager that cooperates with the spatial reuse manager to determine whether the wireless device is permitted to spatially reuse a channel based on whether the wireless device either transmitted the first indication of the first interference level or lowered the first transmit power that the wireless device used to transmit based on the first interference level, wherein the first interference level accurately reflects an amount of interference that does not interfere with the wireless device's communications.

6. The system of claim 1, wherein the first wireless device is not permitted to transmit on the same channel as the second wireless device unless the first indication includes an accurate indication of the first interference level or the first transmit power is based on an accurate determination of the first interference level.

7. The system of claim 1, wherein the second transmit power level is determined to not interfere with communications at the second wireless device based on the second interference level.

8. The system of claim 1, wherein the wireless device is a High-Efficiency Wireless (HEW) device or station.

9. The system of claim 1, wherein the second wireless device is associated with a different Other Basic Service Set (OBSS).

10. The system of claim 1, further comprising a third wireless device including a second transmitter and a second spatial reuse manager configured to either transmit a third indication of a third interference level, or to lower a third transmit power level that the third wireless device will use to transmit, wherein the third transmit power level is based on the third interference level.

11. A method of operating a wireless communications network comprising:
determining a first interference level which a wireless device in the wireless communications network can tolerate;
either transmitting a first indication of the first interference level, or lowering a first transmit power level that the wireless device will use to transmit based on the first interference level;
receiving from a second wireless device a second indication of a second interference level that the second wireless device can tolerate;
determining a second transmit power level, wherein the second transmit power level is based on the second interference level, wherein the transmitter is further configured to transmit on a same channel as the second wireless device with the second transmit power level.

12. The method of claim 11, wherein the wireless device comprises one or more of an analog front end, a security module, memory, one or more antennas, MAC circuitry, and a network access unit.

13. The method of claim 11, wherein the first indication includes the first interference level and an indication of transmission power to be used to transmit the first indication.

14. The method of claim 11, wherein the first wireless device is not permitted to transmit on the same channel as the second wireless device unless the first indication includes an accurate indication of the first interference level.

15. The method of claim 11, further comprising determining whether the wireless device is permitted to spatially reuse a channel based on whether the wireless device either transmitted the first indication of the first interference level or lowered the first transmit power that the wireless device used to transmit based on the first interference level, wherein the first interference level accurately reflects an amount of interference that does not interfere with the wireless device's communications.

16. The method of claim 11, wherein the first wireless device is not permitted to transmit on the same channel as the second wireless device unless the first indication includes an accurate indication of the first interference level or the first transmit power is based on an accurate determination of the first interference level.

17. The method of claim 11, wherein the second transmit power level is determined to not interfere with communications at the second wireless device based on the second interference level.

18. The method of claim 11, wherein the wireless device is a High-Efficiency Wireless (HEW) device or station.

19. The method of claim 11, wherein the second wireless device is associated with a different Other Basic Service Set (OBSS).

20. The method of claim 11, further comprising transmitting a third indication of a third interference level, or lowering a third transmit power level that a third wireless device will use to transmit, wherein the third transmit power level is based on the third interference level.

21. A non-transitory computer-readable information storage media, having stored thereon instructions, that when executed by a processor, perform a method for operating a wireless communications network, comprising:
determining a first interference level which a wireless device in the wireless communications network can tolerate;
either transmitting a first indication of the first interference level, or lowering a first transmit power level that the wireless device will use to transmit based on the first interference level;
receiving from a second wireless device a second indication of a second interference level that the second wireless device can tolerate;
determining a second transmit power level, wherein the second transmit power level is based on the second interference level, wherein the transmitter is further configured to transmit on a same channel as the second wireless device with the second transmit power level.
